(19) United States
(12) Patent Application Publication
(10) Pub. No.: US 2004/0265675 A1
(43) Pub. Date: Dec. 30, 2004

(54) Fuel Cell Flow Field Design

(75) Inventors: Gordon R. Woodcock, Santa Cruz, CA (US); Farrokh Issacci, Playa Del Rey, CA (US); Timothy J. Rehg, Rancho Palos Verdes, CA (US)

Correspondence Address: SUTHERLAND ASBILL & BRENNAN LLP, 999 PEACHTREE STREET, N.E., ATLANTA, GA, 30309, US

(73) Assignee: GENERAL ELECTRIC COMPANY, Schenectady, NY (US)

(21) Appl. No.: 10/604,044

(22) Filed: Jun. 24, 2003

(51) Int. Cl. H01M 8/02

(52) U.S. Cl. 429/38

(57) ABSTRACT

A fuel cell comprising a stack of two or more flow field plates with flow field paths on one or both surfaces of each flow field plate may have a plurality of flow field paths of substantially different length and geometry on each surface. Despite these differences, the electric current density may be substantially uniform among all portions of the fuel cell by providing each flow field path a cross-sectional area determined in proportion to the flow length and geometry of that flow field path.

### FEDERAL RESEARCH STATEMENT

The invention described herein was made in the performance of work under United States Department of Energy Contract No. DE-FC02-97EE50470. The United States Government may have certain rights to this invention.

### BACKGROUND OF INVENTION

The present invention generally relates to fuel cells and, more specifically, to dimensioning of flow field channels in the flow field plates of fuel cells.

Electrochemical fuel cells convert fuel and oxidant to electricity and reaction product. In electrochemical fuel cells employing hydrogen as the fuel and oxygen as the oxidant, the reaction product is water. Such fuel cells generally employ a membrane electrode assembly (“MEA”) consisting of a solid polymer electrolyte or ion exchange membrane disposed between two electrodes formed of porous, electrically conductive sheet material, typically carbon fiber paper. The MEA contains a layer of catalyst, typically in the form of finely comminuted platinum, at each membrane/electrode interface to induce the desired electrochemical reaction. The electrodes are electrically coupled to provide a path for conducting electrons between the electrodes through an external load.

At the anode, the fuel permeates the porous electrode material and reacts at the catalyst layer to form cations, which migrate through the membrane to the cathode. At the cathode, the oxygen-containing gas supply reacts at the catalyst layer to form anions. The anions formed at the cathode react with the cations to complete the electrochemical reaction and form a reaction product.

In electrochemical fuel cells employing hydrogen as the fuel and oxygen-containing air (or substantially pure oxygen) as the oxidant, the catalyzed reaction at the anode produces hydrogen cations (protons or hydrogen ions) from the fuel supply. As hydrogen flows into the fuel cell on the anode side, a catalyst facilitates the separation of the hydrogen gas into electrons and hydrogen ions. The ion exchange membrane facilitates the migration of hydrogen ions from the anode to the cathode. The hydrogen ions pass through the MEA and, again with the help of a catalyst, combine with oxygen and electrons on the cathode side, producing water. In addition to conducting hydrogen ions, the membrane isolates the hydrogen-containing fuel stream from the oxygen-containing oxidant stream. The electrons, which cannot pass through the MEA, flow from the anode to the cathode through an external circuit containing a motor or other electrical load, which consumes the power generated by the cell. At the cathode, oxygen reacts at the catalyst layer to form anions. The anions formed at the cathode react with the hydrogen ions that have crossed the membrane to complete the electrochemical reaction and form liquid water as the reaction product.

In conventional fuel cells, the MEA is interposed between two fluid-impermeable, electrically conductive plates, commonly referred to as flow field plates. The flow field plates serve as current collectors, provide structural support for the porous, electrically conductive electrodes, provide means for carrying the fuel and oxidant to the anode and cathode, respectively, and provide means for removing water formed during operation of the fuel cell. Channels may be formed in the flow field plates for conducting fuel and oxidant, in which case the flow field plates are said to bear the fluid flow field.

Reactant feed manifolds are generally formed in the flow field plates, as well as in the MEA, to direct the fuel (typically substantially pure hydrogen or hydrogen-containing reformate from the conversion of hydrocarbons such as methanol or natural gas) to the anode and the oxidant (typically substantially pure oxygen or oxygen-containing gas) to the cathode via the flow field channels. Exhaust manifolds are also generally formed in the flow field plates, as well as the MEA, to direct unreacted fuel and oxidant, as well as water accumulated at the cathode, from the fuel cell.

Multiple fuel cell assemblies comprising two or more flow field plate-anode--MEA-cathode-flow field plate combinations, referred to as a fuel cell stack, can be connected together in series (or in parallel) to increase the overall power output as required. In such stack arrangements, the cells are most often connected in series, wherein one side of a given fluid flow field or separator plate is the anode plate for one cell, the other side of the plate is the cathode plate for the adjacent cell, and so on.

Fuel cells according to the prior art may have a single path through the flow field, or they may have multiple paths. Examples of single path flow fields are shown in U.S. Pat. Nos. 5,482,680; 5,521,018; 5,527,363; 5,750,281; 5,108,849; 4,988,583; 6,071,635; 5,300,370; 5,879,826; and 5,686,199. Examples of single path serpentine flow fields are shown in U.S. Pat. Nos. 5,482,680; 5,521,018; 5,527,363; 5,750,281; 5,108,849; 4,988,583; 6,071,635; and 5,300,370. Single path serpentine flow fields offer the advantage that all of the flow on the plate passes through a single channel that typically passes back and forth across the entire electrochemical area in a serpentine fashion, thereby insuring that the entire electrochemical area receives reactant. Disadvantages of single path serpentine flow fields include high pressure drop as a large volumetric flow of reactant gas must pass through a single channel. Single pass serpentine flow fields are generally impractical for most applications. A variety of different multiple pass flow fields have been previously disclosed.

Examples of a flow field comprised of multiple straight channels passing from the inlet manifold to the exhaust manifold are disclosed in U.S. Pat. Nos. 5,750,281; 5,879,826; and 5,686,199. In these flow fields comprised of multiple straight channels, each channel is essentially identical to every other channel. In the absence of chemical reaction, each channel would receive identical flow. In a reacting system, however, local variations in reaction rate lead to temperature variations across the flow field, or variations in the amount of reaction by-product in the channels. Local reaction rate variations can be induced by a number of factors including stack geometry and stack cooling approach. For example, in a cross flow stack such as that shown in FIG. 1, the fuel and oxidant flow perpendicular to each other on either side of the membrane 110. The local reaction rate (current density) will be highest near the reaction inlets of the cell, and particularly in the electrochemical area in the vicinity of both cathode and anode reactant inlets. Likewise, the local reaction rate will be lowest in the electrochemical area in the vicinity of both cathode and anode reactant exits. Consequently, heat production will not be uniform across the fuel cell. Similarly with respect to cooling, the coolant temperature will rise as it extracts heat from the fuel cell, thus the stack will have a higher local temperature near the coolant exhaust in comparison to the local temperature near the coolant inlet. These reaction rate variations lead to a variation in flow from channel to channel and sub-optimal performance. An additional disadvantage of flow fields comprised of multiple straight channels is that the pressure drop is very low, thereby making it difficult to remove by-product reactants, such as water. Low pressure drop can also lead to plate to plate flow variations due to a comparable pressure drop between the flow field and manifold. In other words, flow uniformity from plate to plate is accomplished by insuring that the pressure drop across the flow field is substantially larger than the pressure drop in the manifold.

To remedy the low pressure drop associated with multiple straight channels, multiple serpentines are often employed, as shown in U.S. Pat. Nos. 5,981,098; 6,099,984; and 6,071,635. While multiple serpentine flow fields do remedy the low pressure drop of straight channel flow fields, multiple serpentine flow fields do not remedy the issue of local reaction rate variations. Yet another disadvantage of multiple straight channel and multiple serpentine flow fields is that they are difficult to incorporate into flow fields with complex geometry, and they are generally only useful in rectangular flow field plates where the manifolds are located at the perimeter of the plate. For more complex geometry, and also to provide a desirable pressure drop, multi-pass serpentine plates are employed as disclosed in U.S. Pat. Nos. 5,482,680; 5,514,487; 5,547,776; 5,750,281; 5,776,625; 6,048,634; 6,274,262B1; 5,108,849; 6,071,635; and 5,300,370.

In the case of multiple paths, prior-art fuel cells are generally constructed so as to keep all path lengths equal. (For example, U.S. Pat. No. 5,686,199 to Cavalca et al. at lines 42-44 of column 6 and lines 64-66 of column 8, and U.S. Pat. No. 6,037,072 to Wilson et al at lines 19-21 of column 5 and lines 24-26 of column 9). Since these prior-art fuel cells have channels of uniform width and depth, paths of equal length are intended to have equal flow resistance, and thus uniform current density. However, as described above, uniform flow resistance does not guarantee the uniform flow that is necessary for uniform current density. Additionally, different paths may have different numbers of turns or bends, thus imparting different flow resistances since bends offer more resistance than straight portions. Furthermore, different paths may have different relationships between bends and straight portions, which alter the current density for a given flow resistance. A path having a longer straightaway before the first bend, for example, will carry less unreacted fuel into the first bend since some of the fuel has reacted in the straightaway and, thus, incurs less reduction in current density from the resistance of the first bend.

Additionally, it may be desirable or convenient to design fuel cell flow fields with significantly different path lengths and path geometry, which would have markedly different flow resistances. Yet, considerations relating to fuel cell efficiency and to stoichiometry dictate that electric current density be uniform in all paths, which may not be the case with substantially different flow resistances.

While the above descriptions have been presented in the context of PEM fuel cells, other types of fuel cells suffer from similar deficiencies. For example, in solid oxide or molten carbonate fuel cells, large temperature gradients can exist in an operating fuel cell where the coolant is one of the reactants (usually air). Such gradients can cause wide variations in the viscosity of the reacting gases and thereby flow of reactant in the flow field and fuel cell performance.

As can be seen, there is a need for a fuel cell having uniform current density throughout a plurality of flow field paths regardless of path length or path geometry.

### SUMMARY OF INVENTION

In one aspect of the present invention, a flow field plate, comprises at least one flow field path. The flow field path has a width, depth, and length such that a molar flow rate of reactant that enters the flow field path is proportional to an area serviced by the flow field path.

In another aspect of the present invention, a fuel cell comprises at least one flow field plate, the flow field plate having at least one flow field path. The flow field path has a cross-sectional area and length such that a molar flow rate of reactant that enters the flow field path is proportional to an area serviced by the flow field path.

In a further aspect of the present invention, a method for sizing a flow field path in a flow field plate for a fuel cell, comprises steps of: determining an area serviced by the flow field path proportional to a total surface area of the flow field plate; and sizing a cross sectional area and a length of the flow field path so that a molar flow rate of reactant that enters the flow field path is proportional to the area serviced by the flow field path.

In still another aspect of the present invention, a flow field plate, for use in a fuel cell, comprises a plurality of flow field paths. Each flow field path of the multiple flow field paths has a width, depth, and length such that a flow rate of reactant in each flow field path is proportional to an area serviced by each flow field path so that an electric current density is uniform throughout the flow field plate.

These and other features, aspects and advantages of the present invention will become better understood with reference to the following drawings, description and claims.

### BRIEF DESCRIPTION OF DRAWINGS

FIG. 1 is a perspective view of a portion of a fuel cell according to the prior art.

FIG. 2A shows a plan view of a surface of a flow field plate according to one embodiment of the present invention.

FIG. 2B shows a cross sectional view, taken along line 2B-2B of FIG. 2A, of a portion of the surface of a flow field plate according to the embodiment shown in FIG. 2A.

FIG. 3A shows a plan view of a surface of a flow field plate according to an embodiment of the present invention.

FIG. 3B shows an elevation view of a cross-section, taken along line 3B-3B of FIG. 3A, of the flow field plate according to the embodiment shown in FIG. 3A.

### DETAILED DESCRIPTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

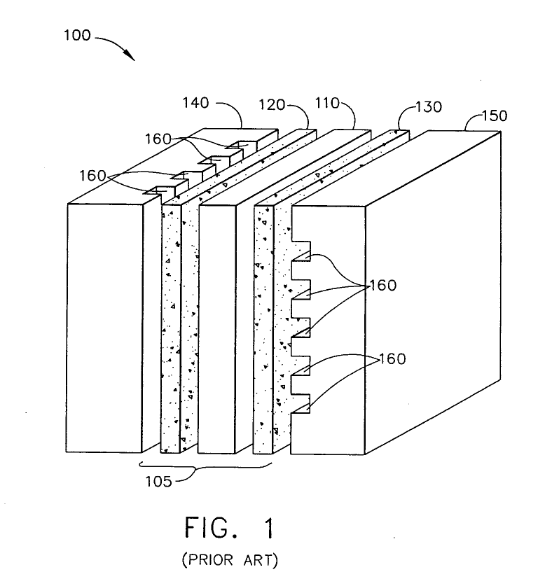

FIG. 1 depicts a central portion 100 of a typical fuel cell according to the prior art. A substantially sheet-like membrane electrode assembly (MEA) 105 includes electrolyte 110 adjacent to first faces of substantially sheet-like electrodes 120 and 130. Adjacent the second face of electrode 120 is flow field plate 140, and adjacent the second face of electrode 130 is flow field plate 150. Flow field plates 140 and 150 each have channels 160 formed in at least one face by, for example, engraving, machining, molding, or stamping. Channels 160 may be formed in both faces of flow field plates 140 and 150 if the fuel cell portion illustrated were being stacked with other similar portions, as known in the art. Channels 160 may be used, for example, for conducting flows of fuel and oxidant through the fuel cell.

To enhance clarity, FIG. 1 is depicted with space between elements 140 and 120, 120 and 110, 110 and 130, and elements 130 and 150. The space is not seen in an actual fuel cell, in which the channeled face of flow field plate 140 is in contact with a face of electrode 120, the opposite face of electrode 120 is in contact with a face of electrolyte 110, the opposite face of electrolyte 110 is in contact with a face of electrode 130, and the opposite face of electrode 130 is in contact with the channeled face of flow field plate 150.

In operation of the fuel cell of FIG. 1 as a hydrogen-oxygen fuel cell, hydrogen (the fuel) may be flowed through channels 160 of flow field plate 140 and oxygen (the oxidant, and often delivered as air) may be flowed through channels 160 of flow field plate 150. Electrode 120, in contact with flow field plate 140, would then be the anode; electrode 130, in contact with flow field plate 150, would then be the cathode. The electrodes 120, 130 may be thin and porous and, for example, are typically made of carbonized paper. Hydrogen atoms thus may pass through electrode 120 to electrolyte 110. Electrode 120 may contain a catalyst (typically platinum) to facilitate the separation of the hydrogen atoms into protons (hydrogen ions) and electrons. Electrolyte 110 may be thin and porous, permitting the hydrogen ions to flow through electrolyte 110 and into electrode 130, where the hydrogen ions may unite with atoms of oxygen permeating electrode 130 from channels 160 of flow field plate 150, forming water which may be carried away by channels 160 of flow field plate 150. The electrons may not permeate electrolyte 110, and may flow from electrode 120 to electrode 130 through an external circuit (not shown) which may contain an electrical load which may consume electrical power produced by fuel cell 100.

One embodiment of the present invention provides a method for forming flow field plates for fuel cells so that the flow field plate functions with flow rates necessary to produce substantially uniform electric current density while maintaining a desired stoichiometric ratio, despite having flow field paths of different lengths or of different geometries, and with adequate pressure drop to sweep liquid from the flow field paths.

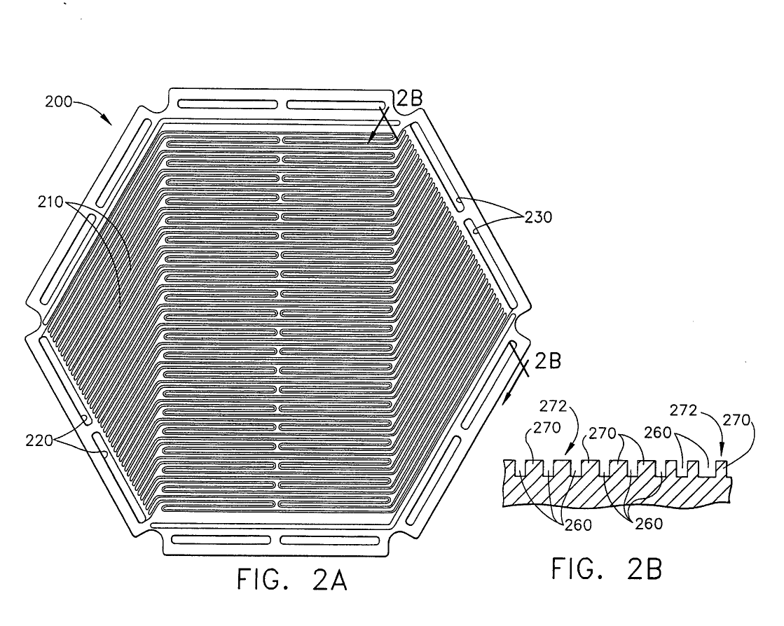

FIG. 2A shows a plan view of flow field plate 200 that may be used in a fuel cell according to one embodiment. Flow field plate 200 has channels 260 arranged in a plurality of flow field paths 210 flowing from inlet manifold 220 to outlet manifold 230. Flow field paths 210 may be of varying lengths, although, in the prior art, all the flow field paths would be of substantially equal length in order that they might have substantially equal flow resistance. The channels 260 (shown in FIG. 2B) are separated from each other by lands 270. The electrochemical area 272 above the land receives reactant from its adjacent channels 260.

In the prior art, flow field paths typically have substantially equal length in order that they might have substantially equal.flow resistance. Prior art flow field paths having substantially equal lengths and the same number of bends, however, may not have substantially equal reactant flow because of differences in the locations of bends along the paths. A fluid path with bends offers more resistance than a straight fluid flow path of the same total length. In the hydrogen-bearing flow field plate, gas in one path may travel less far before encountering a bend than in another path, and may thus have undergone less reaction and contain more hydrogen to flow through the bend, and may thus experience more flow resistance in the bend than the other path. In this case, the former path has a total resistance greater than the latter and will actually experience less flow. The former flow path can be starved of reactant, thereby compromising fuel cell performance. Similarly in the oxygen-bearing flow field plate, gas traveling farther before a bend may have undergone more reaction and thus contain more water, and may thus undergo more flow resistance in the bend. It thus is desirable to construct fuel cells with multiple paths where all paths have flow of reactant proportional to the electrochemical area serviced by the flow path.

Furthermore, it may be convenient to construct fuel cells in which paths through flow field plates have markedly different lengths. This may cause markedly different flow resistances, and the resulting different flow rates may cause markedly different electric current densities from areas fed by the different paths. Yet it is desirable to have a uniform current density throughout the entire fuel cell.

One embodiment of the present invention generally provides paths through flow field plates which are not constrained to being composed of channels of fixed size. The width and depth of channels according to the present invention may be determined as necessary for each individual path so as to enable production of substantially equal electric current density from all portions of a fuel cell regardless of path length or path geometry.

Flow field plate 200, shown in FIG. 2A, provides paths, i.e., flow field paths 210, through flow field plate 200, which are not constrained to being composed of channels of fixed size. Section 2B-2B, shown in FIG. 2B, shows that channels 260 forming flow field paths 210 may be of varying cross-sectional areas. The channels 260 depicted in FIG. 2B are of constant depth but varying width. In alternative embodiments, the depths of channels 260 may vary as well. Thus, the flows through each of flow field paths 210 may be determined individually. The width and depth of channels 260 of flow field plate 200 may be determined as necessary for each individual flow field path 210 so as to enable production of substantially equal electric current density from all portions of a fuel cell regardless of path length or path geometry.

Specifically, if a given channel or flow path services an area A, then the dimensions of the flow path should be selected so that the total resistance of the flow path enables a molar flow rate of reactant, m, of m=iAs/(nF)eqn. (1) where i is the desired current density, n is the moles of electrons produced per mole of reactant consumed, F is Faraday”s constant, and s is the fuel utilization. As the efficiency of a fuel cell is maximized when the current density is everywhere the same, it is clear that the flow rate per channel should be proportional to the area serviced by the flow path, which may not be accomplished if the dimensions of every channel are identical. When the flow paths are not properly sized as described here, the fuel cell must be operated with a low value of s; that is, the reactant utilization must be low to insure that each channel including those receiving less than the desired flow delivers adequate reactant to support the electrochemical reaction in its associated electrochemical area. The fuel cell operates inefficiently in this case (typically s<0.7) as fuel is wasted. When the flow paths are properly sized, s can be increased because now the flow rate of reactant in a channel is proportional to the electrochemical area serviced by the channel. In this more efficient operating mode, the value of s>0.75 (but the value of s is always less than 1).

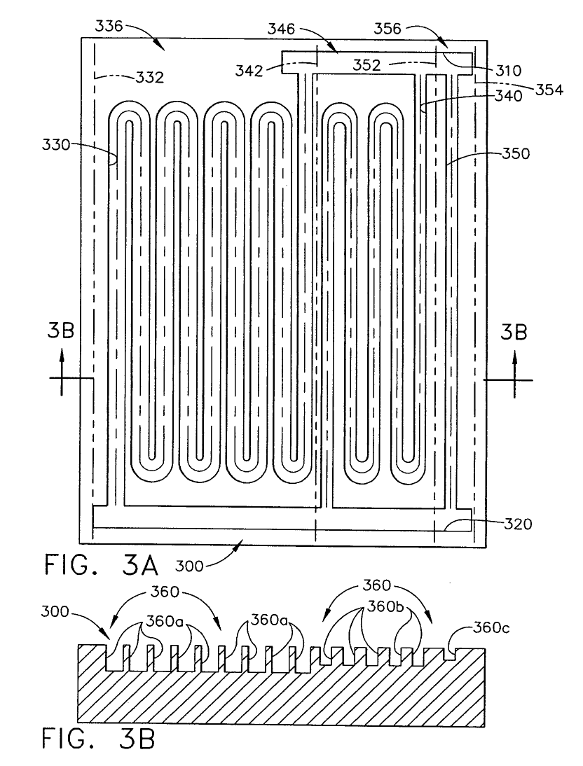

FIG. 3A depicts a flow field plate 300 according to one embodiment the present invention. Connecting between inlet manifold 310 and outlet manifold 320 may be flow field paths 330, 340, and 350. Flow field paths 330, 340, and 350 may be of substantially different lengths. To enhance clarity of illustration, flow field plate 300 is shown having a low density of flow field paths, as compared with, for example, flow field plate 200 of FIG. 2A.

FIG. 3B shows a cross section taken along line 3B-3B, shown in FIG. 3A, through flow field plate 300. Section 3B-3B shows channels 360a, which collectively form flow field path 330, channels 360b, which collectively form flow field path 340, and channel 360c, which forms flow field path 350. Since the length of a flow field path may be substantially proportional to a surface area of a flow field plate serviced by that flow field path, FIGS. 3A and 3B (not drawn to scale) show, generally, that the channels 360 forming a flow field path may be proportional in cross-sectional area to the flow plate surface area serviced by that flow field path. For example, channels 360a may be larger than channel 360c by a ratio determined according to the increased length and resistance characteristics of flow field path 330 compared to the length and resistance characteristics of flow field path 350. Channels 360b may be larger than channel 360c by a ratio determined according to the increased length and resistance characteristics of flow field path 340 compared to the length and resistance characteristics of flow field path 350.

By way of alternate explanation for added clarity, the cross sections of channel 360a (associated with flow field path 330) may be dimensioned to provide a first molar flow rate to service the electrochemical area 336 defined by the surface area of flow field plate 300 that is between lines 332 and 342, as defined by equation (1). Thus, the first molar flow rate may be made proportional to area 336. Likewise, the cross sectional area of channel 360b (associated with flow field path 340), may be dimensioned as defined by equation (1) to provide a second molar flow rate to service the electrochemical area 346 defined by the surface area of flow field plate 300 that is between lines 342 and 352. Thus, the second molar flow rate may be made proportional to area 346. Similarly, the cross sectional area of channel 360c (associated with flow field path 350), may be dimensioned as defined by equation (1) to provide a third molar flow rate to service the electrochemical area 356 defined by the surface area of flow field plate 300 that is between lines 352 and 354 so that the third molar flow rate may be made proportional to area 356. Thus, the current density—represented by i in equation (1)—of areas 336, 346, and 356 may be made equal. In other words, current density may be made to be uniform over the entire surface of flow field plate 300.

Thus, by adjusting the geometry of the flow field channels, for example, adjusting the cross sectional dimensions of each flow field channel relative to itself and to other flow field channels on the same flow field plate and in the fuel cell stack as a whole, one embodiment provides flow rates in each channel based, for example, on the surface area that each channel services and the required stoichiometric ratio, that are adequate to ensure substantially uniform current density in the fuel cell. Uniform current density may provide advantages of higher generated voltage and higher efficiency of the fuel cell.

It should be understood, of course, that the foregoing relates to preferred embodiments of the invention and that modifications may be made without departing from the spirit and scope of the invention as set forth in the following claims.

1. A flow field plate, comprising:
at least one flow field path wherein said at least one flow field path has a width, depth, and length such that a molar flow rate of reactant that enters said at least one flow field path is proportional to an area serviced by said at least one flow field path.

2. The flow field plate of claim 1 wherein:
said at least one flow field path has a width, depth, and length such that a flow rate of reactant in said at least one flow field path is proportional to an area serviced by said at least one flow field path.

3. The flow field plate of claim 1 wherein:
said at least one flow field path has a width, depth, and length such that an electric current density is uniform throughout said flow field plate.

4. The flow field plate of claim 1, further comprising:
a second flow field path wherein said second flow field path has a second width, second depth, and second length such that a second molar flow rate of reactant that enters said second flow field path is proportional to a second area serviced by said second flow field path.

5. The flow field plate of claim 1, further comprising:
a second flow field path wherein said second flow field path has a second width, second depth, and second length such that a second flow rate of reactant in said second flow field path is proportional to a second area serviced by said second flow field path.

6. The flow field plate of claim 1, further comprising:
a second flow field path wherein said second flow field path has a second width, second depth, and second length such that an electric current density is uniform throughout said flow field plate.

7. A fuel cell comprising:
at least one flow field plate, said flow field plate having at least one flow field path wherein said at least one flow field path has a cross-sectional area and length such that a molar flow rate of reactant that enters said at least one flow field path is proportional to an area serviced by said at least one flow field path.

8. The fuel cell of claim 7, wherein:
said at least one flow field plate has at least one flow field path wherein said at least one flow field path has a cross-sectional area and length such that a flow rate of reactant in said at least one flow field path is proportional to an area serviced by said at least one flow field path.

9. The fuel cell of claim 7, wherein:
said at least one flow field plate has at least one flow field path wherein said at least one flow field path has a cross-sectional area and length such that an electric current density is uniform throughout said at least one flow field plate.

10. The fuel cell of claim 7, further comprising:
a second flow field plate having a second flow field path wherein said second flow field path has a second cross sectional area and second length such that a second molar flow rate of reactant that enters said second flow field path is proportional to a second area serviced by said second flow field path.

11. The fuel cell of claim 7, further comprising:
a second flow field plate having a second flow field path wherein said second flow field path has a second cross sectional area and second length such that a second flow rate of reactant in said second flow field path is proportional to an area serviced by said second flow field path.

12. The fuel cell of claim 7, further comprising:
a second flow field plate having a second flow field path wherein said second flow field path has a second cross sectional area and second length such that an electric current density is uniform throughout said second flow field plate.

13. A method for sizing a flow field path in a flow field plate for a fuel cell, comprising steps of:
determining an area serviced by said flow field path proportional to a total surface area of said flow field plate; sizing a cross sectional area and a length of said flow field path so that a molar flow rate of reactant that enters said flow field path is proportional to the area serviced by said flow field path.

14. The method of claim 13, wherein:
in said sizing step, said cross sectional area and said length of said flow field path are sized so that a flow rate of reactant in said flow field path is proportional to said area serviced by said flow field path.

15. The method of claim 13, wherein:
in said sizing step, said cross sectional area and said length of said flow field path are sized to produce substantially uniform electric current density throughout said flow field plate.

16. The method of claim 13, wherein:
in said sizing step, a width, a depth, and said length of said flow field path are sized so that said molar flow rate of reactant that enters said flow field path is proportional to said area serviced by said flow field path.

17. The method of claim 13, wherein: in said sizing step, a width, a depth, and said length of said flow field path are sized so that said flow rate of reactant in said flow field path is proportional to said area serviced by said flow field path.

18. The method of claim 13, wherein:
in said sizing step, a width, a depth, and said length of said flow field path are sized so that an electric current density is uniform throughout said flow field plate.

19. A flow field plate for use in a fuel cell, said flow field plate comprising: a plurality of flow field paths, wherein:
each flow field path of said plurality of flow field paths has a width, depth, and length such that a flow rate of reactant in said flow field path is proportional to an area serviced by said flow field path.

20. The flow field plate of claim 19, wherein:
an electric current density is uniform throughout said flow field plate.
